(19) United States
(12) Patent Application Publication
(10) Pub. No.: US 2011/0192665 A1
(43) Pub. Date: Aug. 11, 2011

(54) NON-CONTACT LIFTING AND LOCOMOTION DEVICE

(76) Inventor: XiaoQi Chen, Christchurch (NZ)

(21) Appl. No.: 13/123,286

(22) PCT Filed: Oct. 9, 2009
(86) PCT No.: PCT/NZ2009/000218

§ 371 Date: Apr. 8, 2011

(30) Foreign Application Priority Data
Oct. 10, 2008 (NZ) 571914

(51) Int. Cl. B60B 39/00; B32B 3/06; B66C 1/02; F16B 47/00; B25J 15/06

(52) U.S. Cl. 180/164; 428/99; 294/183; 248/363; 901/27

(57) ABSTRACT

A Bernoulli-type non-contact adhesion pad comprises a pad area which includes an outer section of the pad area and an inner section of the pad area which is undercut relative to the outer section, at least one aperture in the inner section of the pad area for introducing a pressurised fluid flow from the aperture in use between the pad area and a surface for non-contact adhesion of the pad to the surface, an element extending from the aperture beyond the periphery of the aperture, but not the outer section of the pad area, so that the flow of fluid from the aperture is between and around the element and the periphery of the aperture, the element including an edge around the element at or beyond the aperture. A wall climbing robot using the Bernoulli-type non-contact adhesion pads is also disclosed.

### FIELD OF THE INVENTION

The invention pertains to non-contact lifting devices, an adhesion mechanism, and wall climbing robot device based on the Bernoulli principle.

### BACKGROUND OF THE INVENTION

### Bernoulli Lifting Devices

Lifting devices based on the Bernoulli principle have been employed as non-contact lifting mechanisms for applications such as semi-conductor wafer handling, food handling and materials conveying.

End effectors such as the Bosch Rexroth NCT series lifters (see www.boschrexroth.com/pneumatics) are employed as non contact pick and place devices on materials handling robots such as the ABB Flexpicker.

The degree of lifting force for such devices based on the Bernoulli effect is a function of flow rate, air pressure and position in the flow field. U.S. Pat. No. 6,601,888 provides a description of factors determining the magnitude of lift generated and a description of approaches known in the art.

Existing devices such as the Rexroth NCT 40 device produces 2N of lifting force at a flowrate of 110 l/min using 5 bar operating pressure. The Rexroth NCT 60 device produces a lifting force of 6N at 5 bar operating pressure but requires 210 l/min airflow rate to achieve this force.

### Wall Climbing Devices

Robotic wall climbers have a multitude of uses, for example they can replace humans to perform dangerous tasks such as inspections, maintenance and cleaning in hostile environments, and are used in non-destructive testing applications.

Suction adhesion and magnetic adhesion are the most common attachment mechanisms for wall climbing robots.

Suction adhesion robots typically carry an onboard pump to create a vacuum inside cups which are pressed against a wall or ceiling. Effective suction adhesion is dependent on a smooth impermeable surface to create enough force to hold the robot.

Magnetic adhesion has been implemented in wall climbing robots for specific applications such as nuclear facility inspection. This can be a very reliable technology but requires that the surface allows magnetic attachment.

Other novel adhesion mechanisms such as dry adhesion using synthetic fibrillar adhesives exist, however have limitations for smooth vertical wall applications.

Vortex adhesion mechanisms are also known in the art, as are electrostatic adhesion mechanisms.

### SUMMARY OF INVENTION

An object of the present invention is to provide an improved or at least alternative Bernoulli-type non-contact lifting mechanism and/or wall climbing device.

According to one aspect of the present invention, there is provided a Bernoulli-type non-contact adhesion pad comprising:
a body including a pad area and comprising a pin;
means for coupling the pad to a fluid supply for introducing pressurised fluid flow to a pad area surrounding the pin and over the pad area;
a profiled undercut in said pad area comprising an angled ramp to control in use pressure distribution and maintain the pin at a distance which avoids contact with a surface; said pin including a sharp trailing edge at a point where high velocity fluid exits around the pin to thereby in use additionally entrain adjacent fluid to create a change in static pressure which increases the pressure difference across the device in the region between the surface and the pad area.

In this aspect the invention may also be said to comprise a Bernoulli-type non-contact adhesion pad comprising a pad area which includes an outer section of the pad area and an inner section of the pad area which is undercut relative to the outer section, at least one aperture in the inner section of the pad area for introducing a pressurised fluid flow from the aperture in use between the pad area and a surface for non-contact adhesion of the pad to the surface, an element extending from the aperture beyond the periphery of the aperture, but not the outer section of the pad area, so that the flow of fluid from the aperture is between and around the element and the periphery of the aperture, the element including an edge around the element at or beyond the aperture.

Preferably the pressurized fluid flow exits the trailing edge of the pin in a radial direction where the gap between the pin insert's trailing edge and the undercut intersect.

Alternatively features such as vanes or grooves can be designed into the pin to control the direction in which fluid exits the sharp trailing edge of the nozzle.

It is also possible to introduce the pressurized fluid to the gap between the main body and pin insert in such a way as to introduce a tangential flow component into the incoming fluid stream.

Preferably the pressurized fluid supply is a compressed air supply.

According to a second aspect of the present invention, there is provided a method of improving the lifting force of a Bernoulli-type lifting device comprising establishing a pressurized fluid flow in a device containing a body and pin so that the pressurized fluid flow is directed to an outlet of the pin, a gap in the device between a trailing edge, said pin, and a profiled undercut of an adhesion pad being optimized to entrain adjacent fluid into high velocity fluid flow exiting the outlet of said pin thereby creating a low pressure region which increases lifting force.

According to a third aspect of the present invention, there is provided a robot device comprising at least one Bernoulli-type non-contact adhesion pad which in use can generate sufficient attraction force to maintain adherence to said surfaces, with a force distribution to pressure ratio sufficient to enable adherence to sloping, vertical or inverted smooth and non-smooth surfaces.

The device may be able to carry a payload on sloping, vertical or inverted surfaces where conditions range from smooth to rough, and the device may be able to negotiate over cracks and small gaps and porous surfaces.

Preferably the attraction force achieved from each adhesion pad used in the device is of a ratio producing at least 6N, where the airflow rate is no higher than 52 l/min, and the operating pressure is no greater than 5 bar.

Preferably multiple adhesion pads are utilized in the device.

The device can be connected to a local pressure and power supply.

Alternatively the device can contain an onboard pressurised fluid supply.

Preferably an onboard pressurized fluid supply is achieved with a battery and air compressor.

Preferably the device is modular so that a wide range of control devices and instrumentation can be attached specific to the application chosen.

According to a forth aspect of the present invention, there is provided a robot device capable of adherence to and locomotion along a non-horizontal surface, comprising one or more Bernoulli-type non-contact adhesion pad(s) which in use generate sufficient attraction force to maintain adherence to the surface.

As the improved adhesion pads create suction without touching the wall, at least one contact device which creates high friction is preferable to avoid sliding off the surface.

The contact points are also preferable for movement and manoeuvrability of the device.

Preferably wheels are used to provide locomotion. Wheels allow for high and fast maneuvers. Friction coefficients are optimized for the surfaces targeted. Servo motors are attached to the wheels.

Symmetrical alignment of the adhesion pads and wheels allows the robot to climb in all directions.

Alternatively locomotion can be achieved with for example feet or tracks instead of wheels.

### BRIEF DESCRIPTION OF DRAWINGS

The invention is further described with reference to the accompanying drawings, in which:

FIG. 1 is a graph showing force and pressure distribution in an experimental device

FIGS. 2a-c shows a series of edge designs for the outer diameter of the pad of a device of the invention

FIG. 3 is a graph of maximum force to pressure of three experimental devices.

FIG. 4 is a graph of flow rate obtained with different pressures with three experimental devices.

FIGS. 5(a) and (b) are cross-sectional views of two embodiments of attachment devices.

FIG. 6a is a cross-sectional view of an adhesion pad of an embodiment of the invention, FIGS. 6b and 6c showing parts in expanded detail.

FIG. 7 is a top view of one embodiment of a wall climbing robot of an embodiment of the invention.

FIG. 8 is a graph of maximum attraction forces of an experimental pad on different surfaces.

FIG. 9 is a graph of dependence of attraction force on surface roughness.

FIG. 10 is a graph of dependence of attraction force on clearance gap distance.

FIG. 11 is a graph of dependence of attraction force on orientation angle of a glass surface.

FIG. 12 is an illustration of an adhesion pad crossing a gap.

FIG. 13 is a graph showing dependence of attraction force on gap size.

### DETAILED DESCRIPTION OF EMBODIMENTS

The preferred embodiments of the apparatus of the present invention will be described in reference to the accompanying drawings. These embodiments do not represent the full scope of the invention, but rather the invention may be employed in other embodiments.

The invention makes use of Bernoulli-type lifting force. The magnitude of Bernoulli lift is commonly agreed to be dependent on several factors such as flow rate of the fluid being supplied by the positive pressure fluid source, the density of the fluid, the diameter of the pickup shaft and the pickup opening, the proximity of the pickup surface relative to the object surface and the pressure of the surrounding medium, extent to which the positive pressure fluid can maintain a pattern of laminar flow as it passes through the space between the pickup face and the object, as described in U.S. Pat. No. 6,601,888.

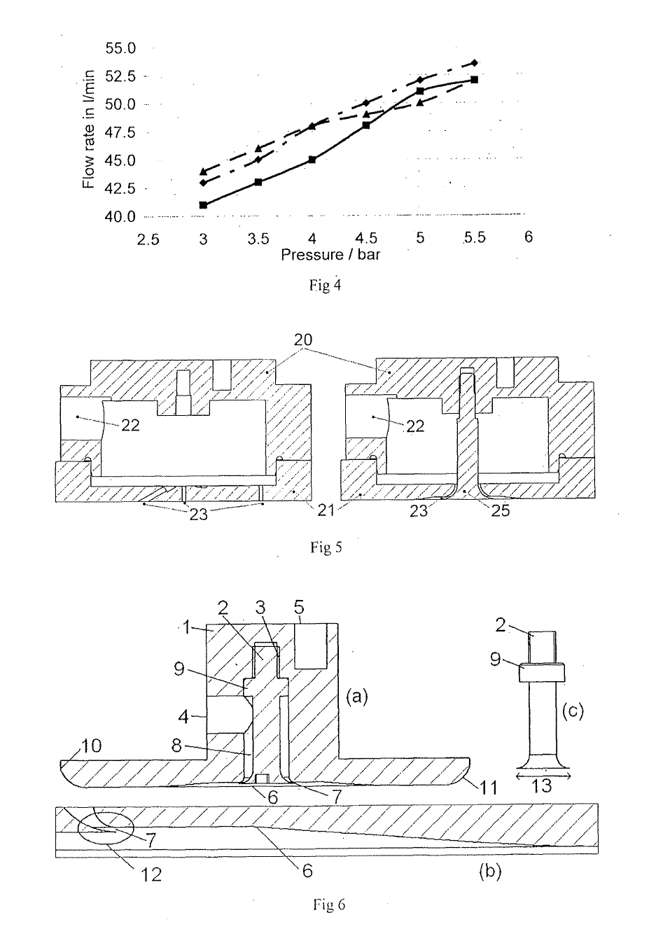

FIG. 6 depicts a device and method which demonstrates sufficient force to pressure ratio to provide the lifting force necessary to adhere a device to a sloping, vertical or inverted surface. The adhesion pad 1 contains a pintel 2 which is located to provide a specific gap 8 to allow pressurized fluid flow, which enters the device 4 to exit the pad through nozzle outlets 7 which have specific dimensions as to optimise the fluid velocity exiting the nozzle 7 and the pad 1. The outer diameter 10 of the pad 1 is optimized, including edge design 11 for the specific application required and contains a ramped undercut 7 which contributes to control of the pressure distribution and also safeguards the pin 2. The lifting force may be augmented with other fluid dynamic phenomena to enhance the fluid pressure difference that holds the pad to a surface. In particular, at a sharp trailing edge of the pintel nozzle 12 the radial flow of high velocity air exiting the pin nozzle entrains fluid flow from the underside of the pin area creating a low pressure region.

FIG. 5b depicts a device similar to FIG. 6 with the exception that the bottom section 21 is detachably connected in order to allow for easy removal and substitution of bottom plates for specific applications.

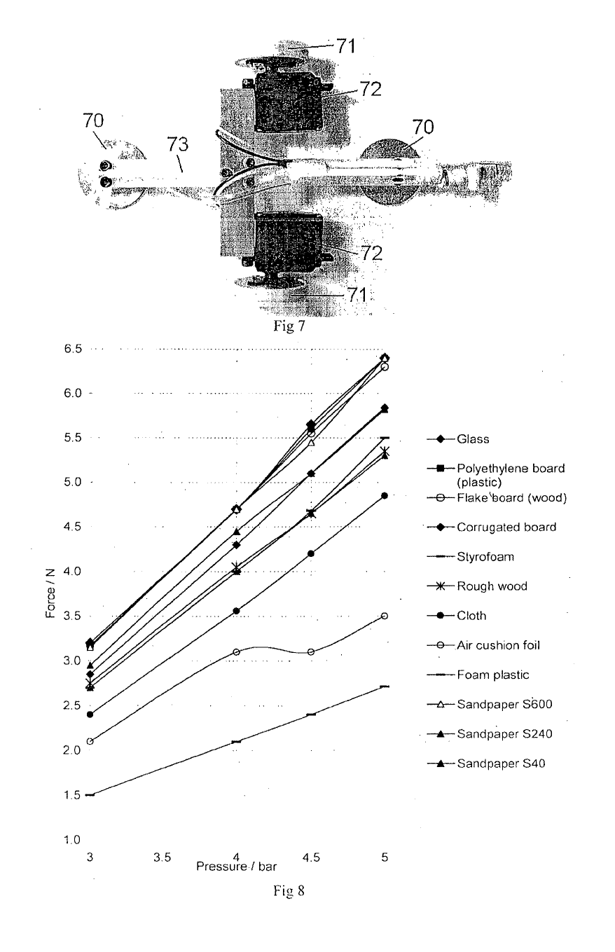

FIG. 7 depicts a wall climbing robot device which employs the adhesion pad design of FIG. 6 in order to adhere to sloping, vertical and inverted surfaces. The wall climbing robot contains two adhesion pads of the design depicted in FIG. 6 each equally splitting the 100 l/min airflow supplied to the device. Servo motors and wheels are added to facilitate positioning and locomotion along vertical surfaces.

The invention is further illustrated by the following description of experimental work, given by way of example and without intending to be limiting.

### Outlet Design

In a Bernoulli lifter, an increase in force results from an increase in fluid flow velocity through the lifter. When the flow is regulated before reaching the nozzle, the gap at the nozzle is not the smallest conduit of the system. The highest velocity of the fluid is reached in the smallest conduit of a pipe system due to the same mass flow in every cross section. Therefore, the velocity at the nozzle decreases because of the flow valve reducing the flow. The highest force is created by the highest fluid speed between device and wall. To reach the maximum fluid speed at the nozzle and consequently between device and wall, the Bernoulli device always has to run with the highest possible flow rate in a working pressure. Therefore, the device has to be designed considering the specifications of the pressure supply.

### Size and Edge Design

It is known that the stream velocity slows down with the radius of a Bernoulli pad, hence the static pressure in the gap increases with the radius. The achieved total force only increases slightly with increase in outer diameter of the pad, but the air gap between the pad and surface becomes narrower, and tilting at of the pad with respect to surfaces becomes more common. A robot should be able to climb surfaces such as walls, so considerations for size and force have to be made.

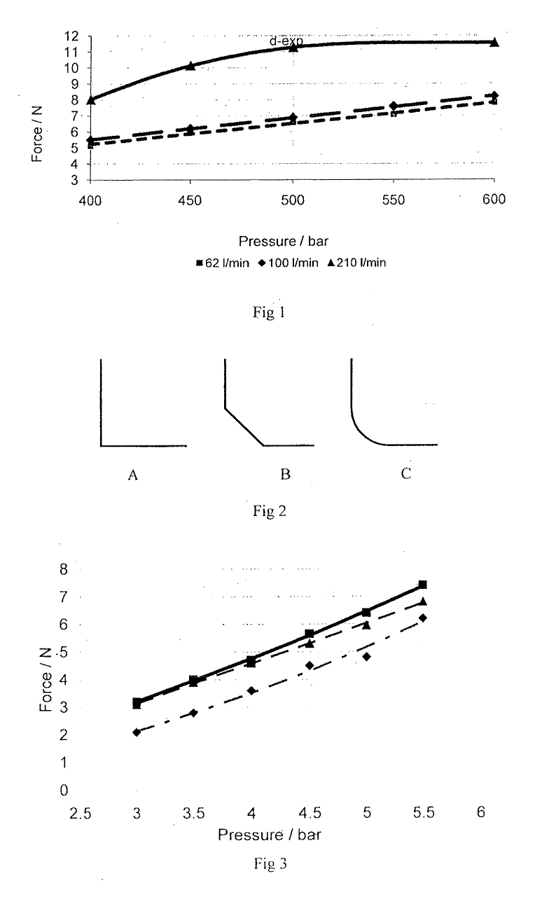

A sharp edge on the Bernoulli pad as shown in FIG. 2a also increases tilting. Therefore, a rounded and an angled edge were tested as shown in FIGS. 2c and 2b. Best performance on surfaces was achieved with the rounded edge. For the angled and rounded edges, compared to the sharp edge there was a very small force reduction, depending on the dimension of the edge alteration. The air stream noise is also reduced by the rounded edge.

### Flow Regulated Attachment Mechanism

Attachment mechanisms as shown in FIG. 5 were made of top and bottom parts 20 and 21 connected with screws (not shown) and a sealing ring (not shown) to avoid loss of air pressure. The top part was connected at 22 to an air supply, while the bottom part comprised compression air outlets 23. The two-part configuration allowed changes of the bottom part for different experiments and fine-tuning the airflow to suit a specific application, and allowed tailoring attraction force and distribution by changing the bottom part only.

In one attachment as shown in FIG. 5a the bottom part 21 comprised seven symmetrically arranged holes and three angled holes 23 with 60 degrees from the vertical direction.

Another attachment as shown in FIG. 5b had only one hole in the middle and a tapered outlet. A matching tapered pin 25 was placed in the hole and screwed into the top part of the device, which deflected the air flow out of the hole radially towards the outer edge of the device. This provided a smooth conduit for air flow guidance as well as additional flexibility in regulating the air flow via screwing in or out of the pin. The airflow rate could be changed by adjusting the pin position.

In both cases the pad was made of lightweight aluminium to reduce the weight of the device.

### Adhesion Pad Design

With reference to a cross section of the body of the pad shown in FIG. 6a, the pad comprises a pad undercut shown enlarged in FIG. 6b and pin insert shown separately in FIG. 6c, the main body 1 is one part with the pin 2 screwed in 3 at the middle. A threaded inlet connection 4 to the pressurised air supply (not shown) was provided. The pad of FIG. 6a was mounted to the wall climbing robot of FIG. 7 with two threads on the top 5.

The outer diameter of the nozzle 6 was 6 mm. The resulting nozzle gap 7 between the pin 2 and the main body 1 to achieve the desired flow rate of 50 l/min at 5 bars for a diameter of 6 mm was only 0.10 mm (and could be made much smaller with a bigger pin 2).

The gap 8 between the pin 2 and the main body 1 was ensured by a tight tolerance at the pin 2 and pin support 3 in the main body 1. A flat stopper 9 was included in the construction of the pin 2 which exactly fit into the 5 mm diameter drilling of the body 1. There was no air flow disturbance at the outlet 7. The pin with the stopper is separately shown in FIG. 6c.

The undercut 9—see FIG. 6b—safeguards the pin 2. Because the main body 1 was closer to the surface (not shown) than the pin 2, the pin 2 avoids being in contact with the surface (not shown). As such, potential scratching of the pin 2 and damage of the nozzle system 12 is prevented.

The angled ramp of the undercut 9 serves as a guide for outlet air. It reduces the clearance distance between the surface (not shown) and the pad so that the air speed reduction due to the increasing radius was slowed down. This otherwise results in a slower increase of pressure and likewise a decrease of attraction force. In one experimental pad the outer diameter of the main body 10 was reduced to 45 mm including a rounded edge with a radius of 3 mm. This reduction of diameter was a trade off between attraction force and the ability to compensate for tilting. With the slightly reduced outer diameter 10 and the rounded edge 11, the pad could also accommodate small tilts which may be encountered when the robot (not shown) transverses on an uneven surface (not shown).

### Improved Lifting Force

Lifting force has been increased by augmenting the Bernoulli effect with other fluid dynamic phenomena to enhance the air pressure difference that holds the pad to a surface.

In particular, at the sharp trailing edge of the pin insert nozzle 12, the radial flow of high velocity air exiting the pin nozzle entrains fluid flow from the underside face of the pin creating a low pressure region.

### Attraction Force on Various Surfaces

Two pads as described with reference to FIG. 6 were constructed and tested 7. A flow of 51 l/min at 5 bars was used. FIG. 3 shows the lifting force to pressure comparing the device of FIG. 6—filled squares with the device of FIG. 5a—onfilled diamonds, and a flow rate setting of 50 l/min and the device of FIG. 5b—filled triangles. The flow rate behaviour of the devices over pressure is shown in FIG. 4.

In all three cases, the attraction forces increase proportionally with the pressure. The device of FIG. 5b offered a higher force than that of FIG. 6 at the same pressure. At the pressure of 5 bars, the maximum force of 6.4 N was achieved on a glass surface.

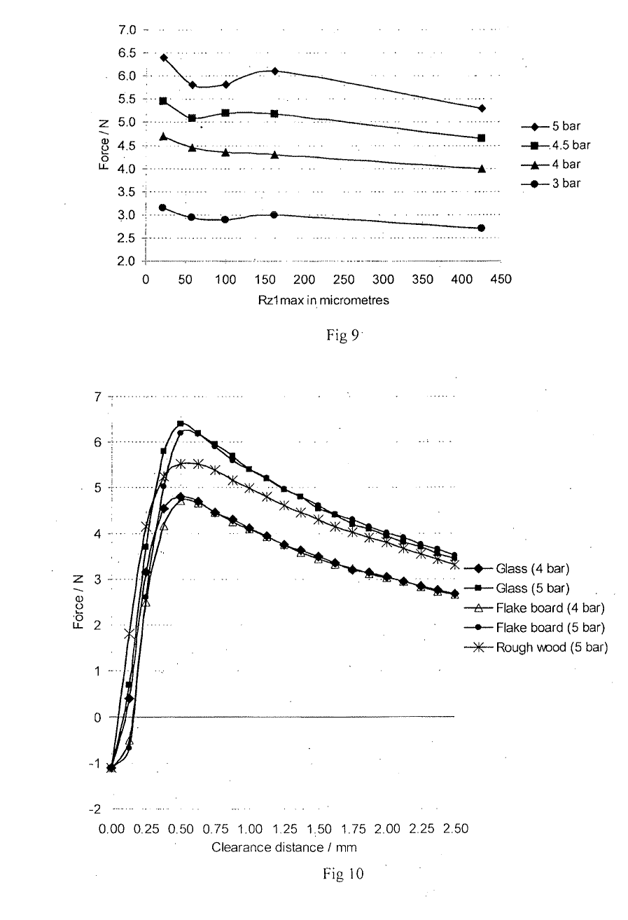

To use the attachments for wall climbing robots, it was desired to have a reliable adhesion on different surface materials and surface conditions. Therefore, many experiments were carried out on metal, plastic and wooden surfaces, and finally expanded to different grained sandpapers and other materials with results shown in FIG. 8. The attraction force was shown to be dependent on surface roughness as shown in FIG. 9.

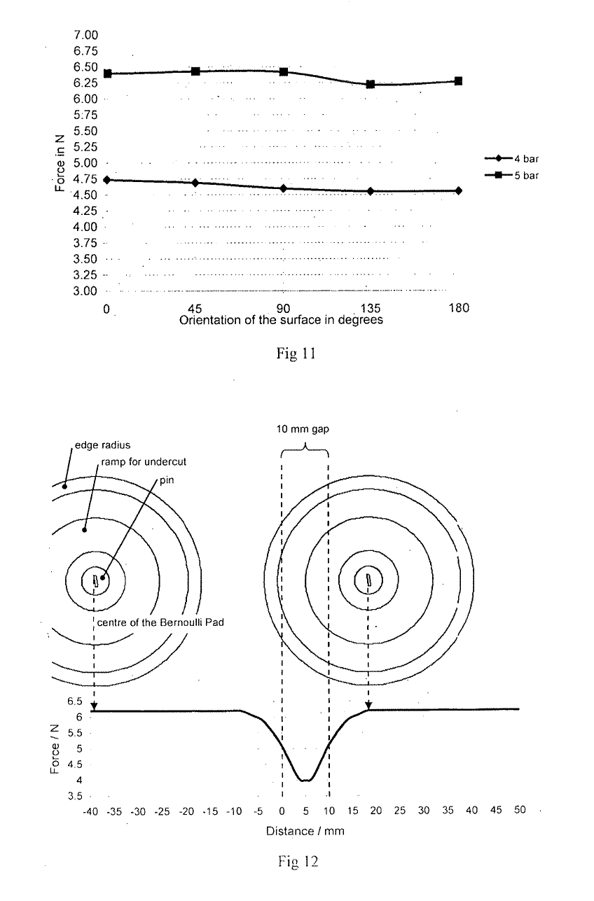

Attraction force was also shown to be dependent on the clearance distance between the pad and the surface, as shown in FIG. 10, and the orientation angle to the surface as shown in FIG. 11.

Tests were also conducted with simulated cracks on the surface.

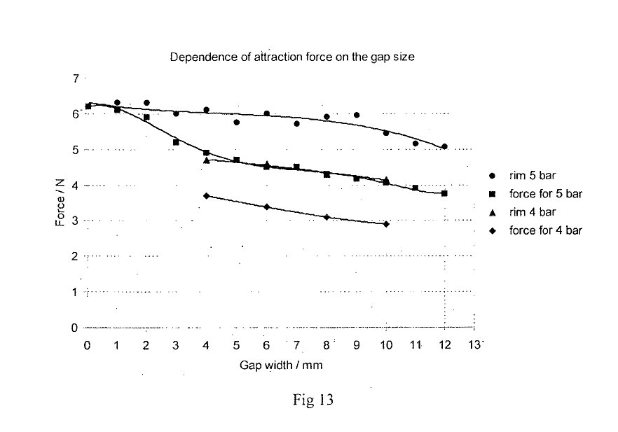

The results are shown in FIG. 12 and FIG. 13.

### Wall-Climbing Robot

An air supply system delivering a pressure of 5 bars and a permanent flow rate of 120 l/min was used. A robot as shown in FIG. 7 was constructed with two pads 70 of the design shown in FIG. 6. For each pad to reach 50 to 60 l/min flow rate equally, the most important design consideration is the nozzle opening. In the prototype robot, the nozzle with 6 mm diameter and a very precise opening gap of 0.10 mm achieved equal air flow between two pads. The weight of one suction pad, made of aluminium, was 19 grams. The tube fitting for the pressure supply weighed 4 grams. One pad operating with an air flow of 51-52 l/min at a pressure of 5 bars created a force of 6.0 N. The attraction force generated was relatively consistent for different surfaces.

As the Bernoulli-type pads are non-contact, and flow over an air cushion, the robot needs contact physical points to remain in a controlled position on a wall by relying on the friction force, such as one or more wheels 71 driven by DC motors 72. With a high friction coefficient wheel material, the friction force is high enough to stabilise the robot and any onboard tools on a vertical wall.

The prototype robot was able to climb on a variety of surfaces. Best results were achieved with a combination of a rubber with a friction coefficient of 0.74 on glass with a thin strip of Velcro which supports climbing on cloth and very raw surfaces. The wheel(s) can be changed to the best material(s) for the desired application. For different surfaces, wheels can be changed on-site.

Stability of the prototype robot was achieved through two Bernoulli suction pads in the front and at the back of the robot at a distance of 180 mm. These non-contact devices self-place them in a distance of about 0.5 mm of the wall. The whole robot was designed symmetrically in two axes, so that the stability still maintains when the robot is climbing with the head down. The main body was made out of a plastic bar 73 with a T-profile to reduce the total weight and to achieve high stiffness. To get the best transfer of the suction force to the contact points, a lightweight suspension system for the wheels is preferably provided. The motor(s) and wheels may be mounted on a thin and flexible aluminium beam, which is elastic enough to act as a suspension system.

The prototype wall climbing robot is shown in FIG. 7. Its total length was 224 mm and its width was 156 mm. The robot was driven using two gear-head micro motors. One drive train had a weight of only 38 grams. In total the robot weighed 234 grams and was able to lift an additional weight of 500 grams on a vertical concrete surface as well as on a glass surface. It can move in all directions: forward, backward, left, right, and upside down.

The design achieved 12 N for a robot weighing 234 grams, with the force/weight ratio being as high as 5.

In addition to reliable adhesion on various surface types, another advantage of the device is that it is “self-cleaning” of the surface. When the robot climbs on a dirty and dusty surface, the air stream cleans the surface and for example so prepares it for surface inspection using an onboard measuring instrument.

A standard high pressure supply or a compressor can be used. Batteries for instruments and motors can be mounted on board. The robot can be steered by a remote control or may be arranged to autonomously navigate using onboard sensors and controllers. Because of the simple but very effective wheeled locomotion and only two suction pads of the prototype, a simple control system can be employed to steer the movement.

The non-contact adhesion method opens up great potential for wide industrial adoptions such as structural inspection, surveillance, part transporting in bio-medical, inspection, and tank welding.

Aspects of the present invention have been described by way of example only and it should be appreciated that modifications and additions may be made thereto without departing from the scope thereof as defined in the accompanying claims.

1-19. (canceled)

20. A Bernoulli-type non-contact adhesion pad comprising:
a body including a pad area and comprising a pin;
means for coupling the pad to a fluid supply for introducing pressurised fluid flow to a pad area surrounding the pin and over the pad area;
a profiled undercut in said pad area comprising an angled ramp to control in use pressure distribution and maintain the pin at a distance which avoids contact with a surface; said pin including a sharp trailing edge at a point where high velocity fluid exits around the pin to thereby in use additionally entrain adjacent fluid to create a change in static pressure which increases the pressure difference across the device in the region between the surface and the pad area.

21. The adhesion pad according to claim 20 arranged so that in use the high velocity fluid flow exits the trailing edge in a radial direction where the gap between the pin trailing edge and the undercut intersect.

22. The adhesion pad according to claim 20 comprising vanes or grooves fabricated into the pin outlet to control the direction in which in use high velocity fluid exits the sharp trailing edge of the pin outlet.

23. The adhesion pad according to claim 20 arranged so that in use pressurized fluid can be introduced to the gap between the main body and pin in such a way as to introduce a tangential flow component into the pressurized fluid stream.

24. A method of improving the lifting force of a Bernoulli-type lifting device comprising establishing a pressurized fluid flow in a device containing a body and pin so that said pressurized fluid flow is directed to an outlet of the pin, a gap in the device between a trailing edge, said pin, and a profiled undercut of an adhesion pad being optimized to entrain adjacent fluid into high velocity fluid flow exiting the outlet of said pin thereby creating a low pressure region which increases lifting force.

25. The method according to claim 24 wherein the pressurized fluid flow is a compressed air flow.

26. A robot device comprising at least one Bernoulli-type non-contact adhesion pad which in use can generate sufficient attraction force to maintain adherence to said surfaces, with a force distribution to pressure ratio sufficient to enable adherence to sloping, vertical or inverted smooth and non-smooth surfaces.

27. A robot device capable of adherence to and locomotion along a non-horizontal surface, comprising one or more Bernoulli-type non-contact adhesion pad(s) which in use generate sufficient attraction force to maintain adherence to the surface.

28. The robot device according to claim 27 also comprising at least one contact device for maintaining the device at a set position on the surface.

29. The robot device according to claim 26 including means for connecting a pressurized fluid supply to the device through a tether.

30. The robot device according to claim 26 including an on board pressurised air supply.

31. The robot device according to claim 28 wherein the at least one contact device also provides a source of locomotion along the surface.

32. The robot device according to claim 28 wherein the at least one contact device is a wheel.

33. The robot device according to claim 32 including a motor arranged to drive the at least one wheel.

34. The robot device according to claim 27 comprising control devices and/or instrumentation attached to the device.

35. A Bernoulli-type non-contact adhesion pad comprising a pad area which includes an outer section of the pad area and an inner section of the pad area which is undercut relative to the outer section, at least one aperture in the inner section of the pad area for introducing a pressurised fluid flow from the aperture in use between the pad area and a surface for non-contact adhesion of the pad to the surface, an element extending from the aperture beyond the periphery of the aperture, but not the outer section of the pad area, so that the flow of fluid from the aperture is between and around the element and the periphery of the aperture, the element including an edge around the element at or beyond the aperture.

36. The Bernoulli-type non-contact adhesion pad according to claim 35 wherein said inner section of the pad area slopes in an annular ramp from the aperture to the outer section of the pad area.
